(19) United States
(12) Patent Application Publication
(10) Pub. No.: US 2023/0229585 A1
(43) Pub. Date: Jul. 20, 2023

(54) SYSTEM AND METHOD FOR TEST CODE GENERATION IN SOFTWARE TESTING

(71) Applicant: 4Test-Plus Kft., Budapest (HU)

(72) Inventor: István FORGÁCS, Budapest (HU)

(21) Appl. No.: 18/097,730

(22) Filed: Jan. 17, 2023

Related U.S. Application Data
(60) Provisional application No. 63/299,609, filed on Jan. 14, 2022.

(51) Int. Cl. G06F 11/36

(52) U.S. Cl. CPC G06F 11/3684; G06F 11/3676; G06F 11/3664

(57) ABSTRACT

The computer-implemented method for producing a test code for automated testing a software comprises providing a high-level test model for modelling a set of requirements for the software to be tested; generating a plurality of high-level test cases on the basis of the high-level test model; providing a human tester with the software to be tested; executing the software; prompting the human tester to execute the high-level test cases by the software under test with using input values arbitrarily selected from an available set of input values of the software in accordance with the high-level test model; producing a plurality of low-level test models for the high-level test cases by the human tester; and generating a computer-executable test program code for the low-level test models.

### FIELD OF INVENTION

The present invention generally relates to software testing. More specifically, the present invention relates to a system and a method for test code generation based on a plurality of test cases.

### BACKGROUND ART

A basic element of the quality assurance of software systems is software testing. Software testing is a process of validating and verifying that a software program, application or product meets the business and technical requirements that guided its design and development, it works as expected, and it can be implemented with the same characteristics. Software testing is a critical component in the development of software.

Nowadays test cases are executed automatically. In this way test cases can be executed several times a day, after some code modification. Test execution automatization is therefore a key part of the whole software testing process. Automatized tests can be executed as frequently as needed. This is a very important process of software development as the cost of bug fixing increases non-linearly over the time that the bug is detected after putting it into the code. The main problem of automated testing is how to create a test code very fast.

One of the test automation methods is the so-called “capture and playback” scheme, wherein the tests are carried out and a machine-executable test code is generated during the test runs. However, this scheme has the drawback that test cases are difficult to maintain since the test cases are not structured, the same test steps are recorded several times and it is difficult to find them to modify. It is also difficult to eliminate the obsolete tests in this scheme.

Another conventional method of software testing is making executable test code manually. In this case the maintenance becomes cheaper, however, the effort needed for test creation is considerable and when applying an agile methodology, the automated tests will not be ready within the required time frame such as a sprint.

A further common method of software testing is the model-based testing. In this testing approach, a test model is created and machine-executable test code is automatically generated based on the test model. The problem with this testing approach is that the model should contain all the events and validation a tester should do during executing a test case. It is easy to make a mistake in the model that will be manifested in the test case, and if a mistake happens at the beginning of a test case, then the subsequent steps of the model should be rewritten. This makes a test case to pass a time-consuming task.

The U.S. Pat. No. 8,543,980 discloses a method for testing software, the method comprising providing a current state, a plurality of test objects, and a plurality of test methods, wherein the current state includes a first set of test objects that has at least one test object, the test methods can be associated with one or more state transitions, and each test method is associated with one test object; identifying each test method associated with at least one test object included within the first set of test objects; obtaining input that selects a test method; modifying the current state if the selected test method is associated with a state transition that results in a state different from the current state, the modified current state including a second set of test objects that has at least one test object, wherein at least one test object is not included in both the first set of test objects and the second set of test objects; identifying each test method associated with at least one test object included within the second set of test objects; and generating a test script that executes the software. This method uses only a limited number of test cases based on only those keywords that are available at a specific point in navigation. Although this method allows rapid development and maintenance of test cases, it cannot be used for an exhaustive verification of all possible test cases of complex software.

The object of the present invention is to further improve the efficiency of software testing.

The above object is achieved by providing a method for test code generation is provided. The method comprises providing a high-level test model for modelling a set of requirements for the software to be tested; generating a plurality of high-level test cases, by means of a test case generation module, on the basis of the high-level test model; providing a human tester with the software to be tested, said software being implemented on the basis of said set of requirements; executing the software controlled by a test automation tool; prompting the human tester to execute the high-level test cases by the software under test with using input values arbitrarily selected from an available set of input values of the software in accordance with the high-level test model; producing a plurality of low-level test models, by means of the test automation tool, for the high-level test cases by the human tester; and generating a computer-executable test program code for the low-level test models by the test automation tool.

The above object is further achieved by providing a system for test code generation. The system comprises a computing device configured to provide a high-level test model for modelling a set of requirements for the software to be tested; generate a plurality of high-level test cases, by means of a test case generation module, on the basis of the high-level test model; provide a human tester with the software to be tested, said software being implemented on the basis of said set of requirements; execute the software controlled by a test automation tool; prompt the human tester to execute the high-level test cases by the software under test with using input values arbitrarily selected from an available set of input values of the software in accordance with the high-level test model; produce a plurality of low-level test models, by means of the test automation tool, for the high-level test cases by the human tester; and generate a computer-executable test program code for the low-level test models by the test automation tool.

The above object is also achieved by providing a non-transitory computer-readable medium encoded with programming instructions configurable to cause a computing device to perform the method of the invention for test code generation.

### BRIEF DESCRIPTION OF THE DRAWINGS

The invention will now be described with reference to the accompanying drawings, in which:

FIG. 1 is a flow diagram of the main steps of the method for test code generation in accordance with the present invention.

FIG. 2 illustrates an example of specific requirements for the software to be tested.

FIG. 3 illustrates an exemplary high-level test model for the exemplary software requirements shown in FIG. 2 in accordance with the present invention.

FIG. 4 illustrates high-level test cases generated form the high-level model of FIG. 3 in accordance with the present invention.

FIGS. 5A to 5D illustrate exemplary low-level test models based on the high-level test cases shown in FIG. 4.

FIG. 6 illustrates an executable test program code generated from the low-level test models shown in FIGS. 5A to 5D.

FIG. 7 illustrates the components of the test code generation system according to the present invention.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

In the present specification, a two-phase model-based test code generation is introduced for automated software testing. The test automation tool uses two-phase modelling, wherein a high-level test model is created by a human tester, and the low-level test model is automatically generated from the high-level test model. The test automation tool also generates a machine-executable test code for execution by the test execution tool. The system of the invention allows fast and efficient automated software testing.

In one embodiment, a computer-implemented method for test code generation is provided. The method comprises providing a high-level test model for modelling a set of requirements for the software to be tested; generating a plurality of high-level test cases, by means of a test case generation module, on the basis of the high-level test model; providing a human tester with the software to be tested, said software being implemented on the basis of said set of requirements; executing the software controlled by a test automation tool; prompting the human tester to execute the high-level test cases by the software under test with using input values arbitrarily selected from an available set of input values of the software in accordance with the high-level test model; producing a plurality of low-level test models, by means of the test automation tool, for the high-level test cases by the human tester; and generating a computer-executable test program code for the low-level test models by the test automation tool.

In the method of the invention, a high-level test model is first created by a human tester. The high-level test model contains a brief description of the test. From the high-level test model, a plurality of high-level test cases is generated. The high-level test cases can be easily executed by a human tester but they cannot be executed by computer tools. During the execution of the high-level test cases by the human tester with applying specific input values and checking the correct operation of the software under test, a plurality of low-level test models is produced, from which a specific computer-executable test code may be generated for a test execution tool. During the test execution, validation is made by the selection of the output values or the states of the user interface objects of the software under test.

In the following, the method of generating a test code for automated software testing will be described through a simple example of a webshop operating software.

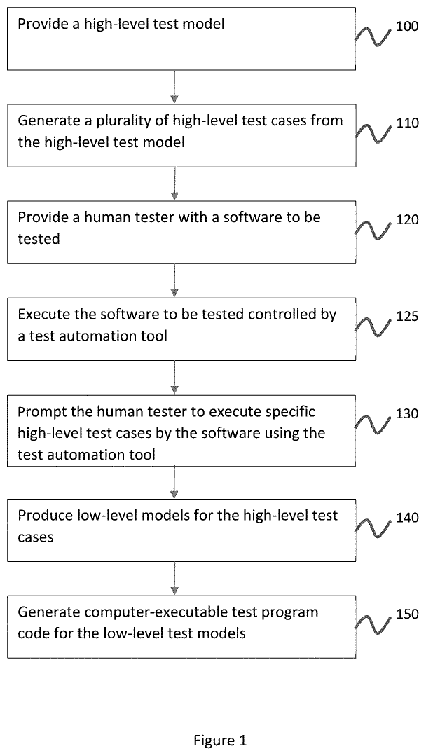

The main steps of the method are shown in FIG. 1. In a first step 100, a high-level test model is provided in textual form, which is interpretable only by humans. The high-level test model is created on the basis of a written software specification, referred to as “requirements” below, either manually, for example by an operator of the software, or automatically by means of an appropriate computer-implemented text processing tool. The high-level test model shall satisfy the following two criteria:
1. a plurality of high-level test cases can be generated from it, and
2. a human tester can execute the high-level test cases in the software under test.

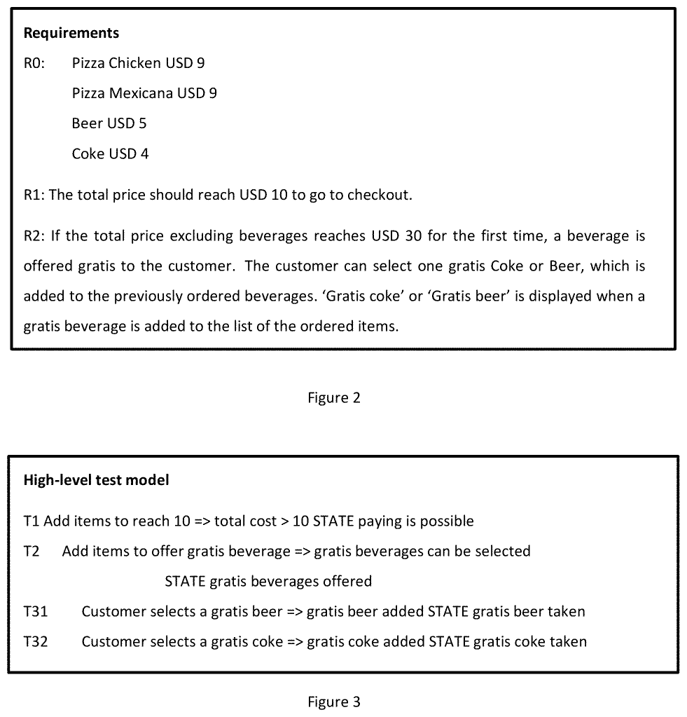

A simple example of the software requirements is presented in FIG. 2 in textual form. In this example, requirement R0 specifies the products (e.g. pizzas and beverages) available in the webshop, along with their prices. Requirement R1 specifies the minimum total price of shopping, which is USD 10 in this example. Requirement R2 specifies the rules of giving a gratis beverage to the customer.

For the sake of simplicity, in the present example, only positive test cases are modelled, i.e., the test cases when items are only added and no item is deleted during the ordering process.

The high-level test model is manually created on the basis of the written software requirements using predefined syntactic rules. An exemplary high-level test model generated on the basis of the requirements shown in FIG. 2 is illustrated in FIG. 3, also in textual form. In this example, in each numbered line the first term is an action, which the human tester should take. The second term, after the sign “=>” is the software's (systems') response, the which the human tester should check. The third term, after the word “STATE” is the state at which the test system arrives as a result of the respective input. Consequently, as shown in FIG. 3, the high-level test model contains instructions for the human tester to perform and conditions to be checked by the human tester in a form interpretable only by human.

In step 110 of the method, a plurality of high-level test cases is generated on the basis of the high-level test model. The high-level test case generation uses the following rules:
1. If a step is indented right with respect to the previous step, the step is executed within the same test case, subsequently after the previous step.
2. If a step is indented identically with respect to the previous step, the step is executed alternatively in a different test case.

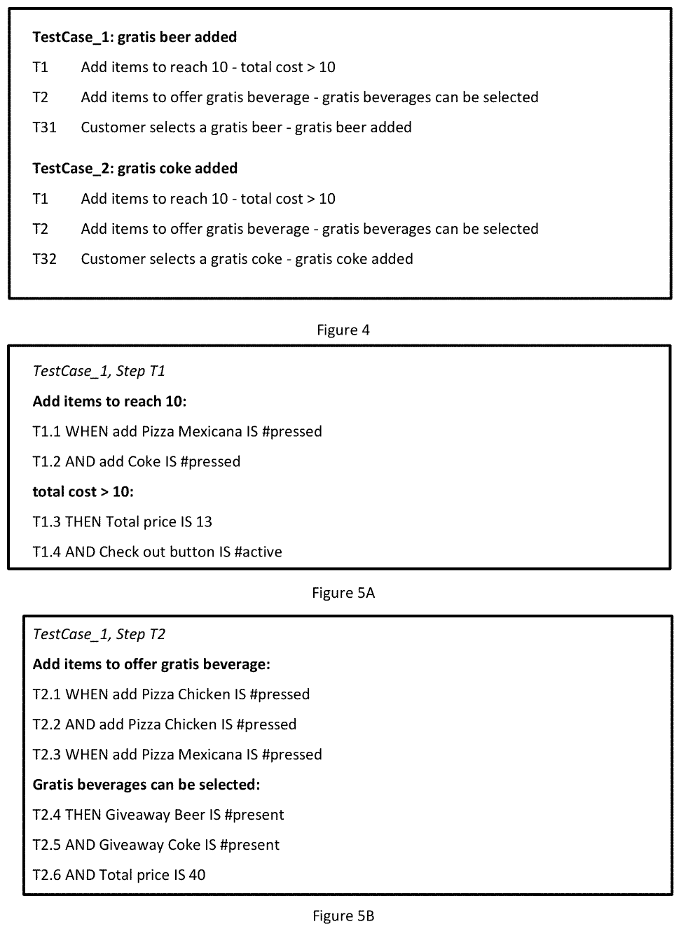

Accordingly, from the high-level test model shown in FIG. 3, two test cases may be generated, in which the first two steps T1, T2 of the test cases are the same, while the third steps T31, T32 of the two high-level test cases are different. The two high-level test cases generated on the basis of the high-level test model of FIG. 3 are illustrated in FIG. 4. The first high-level test case “TestCase_1” includes steps T1, T2 and T31, and the second high-level test case “TestCase_2” includes steps T1, T2 and T32.

As mentioned above, the high-level test cases are automatically generated from the high-level test model by the test code generation system of the invention. Due to the free text form of the high-level test cases, the high-level test cases cannot be executed by a computer in general with considering the current state of the art, they are only intended to execute by a human tester. It is noted that in the high-level test cases, the contents of the “STATE” terms of the high-level test model may be omitted as done in the example shown in FIG. 4. In this case, the high-level test cases contain multiple pairs of an action to be performed and a response to be checked.

In one embodiment of the method, all possible high-level test cases are generated for the high-level test model.

In step 120 of the method, an executable code of the software to be tested is provided with the human tester for testing the software using the previously generated high-level test cases. Normally, the software to be tested has been implemented by an independent software developer on the basis of the same requirements as those of the high-level test model.

In step 125, the software is executed under the control of a test automation tool for carrying out different specific high-level test cases with the software.

In step 130, the human tester is prompted to execute each high-level test case using the user interface of the software under test. For one high-level test case, any number of specific test steps may be executed by the human tester. When executing a specific high-level test case, the human tester may choose any appropriate value for the input parameters from a respective set of available input values of the software under test, and he should check whether the response of the software to the given input action is correct. The input values are selected by the human tester in accordance with the high-level test model.

The high-level test cases are executed controlled by a test automation tool, which is a computer program automatically detecting user actions through the user interface of the software. This tool also functions to generate, in step 140, a low-level test model for each specific high-level test case with a predetermined or user-defined syntax.

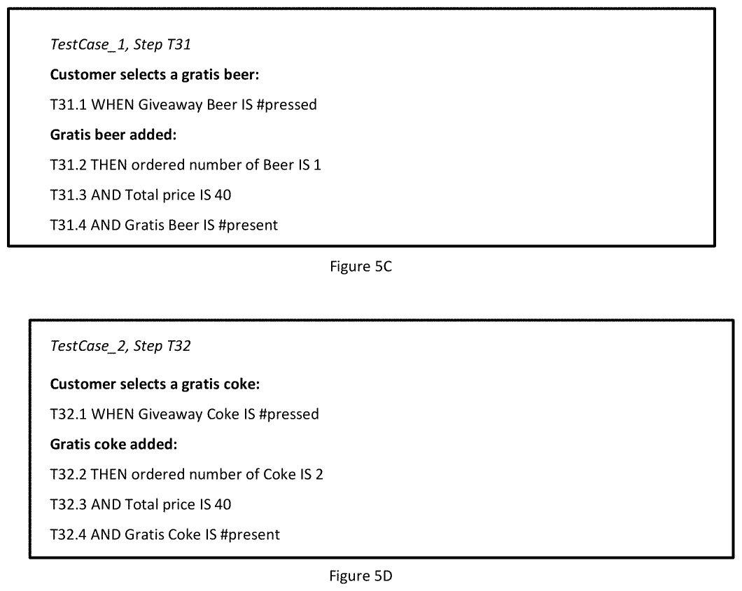

When manually executing, by a human tester, the two test cases TestCase_1 and TestCase_2 shown in FIG. 4, the low-level test model corresponding to steps T1, T2, T31 and T32 of the high-level test cases are automatically generated by the system of the invention. Examples of low-level test model of steps T1, T2, T31 and T32 of the high-level test cases are shown in FIGS. 5A to 5D.

For example, the first two specific test step may include selecting a Pizza Mexicana and a Coke. In this case, as shown in FIG. 5A, step T1 of the first or second high-level test case TestCase_1, TestCase_2 may be mapped into the low-level machine-readable steps T1.1 to 11.4.

In step T1.1, the selection of ‘Pizza Mexicana’ by the human tester is detected, and in step 11.2, the selection of ‘Coke’ is detected, both being an action of the human tester. In step 11.3, the human tester checks the value of the total price presented by the software is greater than USD 10, and if so, he confirms the value of the total price (which is USD 13 in this case). Finally, in step 11.4, the human tester checks whether the ‘Check out’ button is active, and if so, he confirms its status.

The next three specific test steps may include selecting two Pizza Chickens and a Pizza Mexicana. In this case, as shown in FIG. 5B, step T2 of the first or second high-level test case TestCase_1, TestCase_2 may be mapped into the low-level machine-readable steps T2.1 to T2.6.

In steps T2.1 and T2.2, the selection of a ‘Pizza Chicken’ and in step T2.3, the selection of an additional ‘Pizza Mexicana’ by the tester is detected. In steps T2.4 and T2.5, it is checked by the human tester whether the gratis beverages (i.e. ‘Beer’ and ‘Coke’) are offered by the software, and if so, the human tester confirms it. Then, in step T2.6, it is checked by the human tester whether the total price is USD 40, and if so, he confirms the value of the total price.

A subsequent specific test step of TestCase_1 may include selecting a gratis Beer. In this case, as shown in FIG. 5C, step T31 of the first high-level test case TestCase_1 may be mapped into the low-level machine-readable steps T3.1 to T3.4.

In step 131.1, the selection of a gratis Beer by the human tester is detected, and then in step T31.2, it is checked by the human tester whether the ordered number of Beer is set to ‘1’ and if so, he confirms the value. In step 131.3, the human tester checks whether the total price remains the same (i.e. USD 40 in the present example), and if so, he confirms the value of the total price. Finally, in step T31.4, the human tester checks whether the gratis Beer is presented by the software and if so, he confirms it.

A specific test case realizing high-level test step T32 may include selecting a gratis Coke. In this case, as shown in FIG. 5D, step 141 of the second high-level test case TestCase_2 may be mapped into the low-level machine-readable steps 14.1 to T4.4.

In step T41.1, the selection of a gratis Coke by the human tester is detected, and then in step 141.2, it is checked by the human tester whether the ordered number of Coke is set to ‘2’ and if so, he confirms the value. In step 141.3, the human tester checks whether the total price remains the same (i.e. USD 40 in the present example), and if so, he confirms the value of the total price. Finally, in step T41.4, the human tester checks whether the gratis Coke is presented by the software and if so, he confirms it.

The actions of the human tester and the responses of the software are tracked by the test automation tool of the system of the invention, which automatically produces a plurality of low-level test models for the tester actions and software responses of the specific high-level test cases (e.g. the program codes shown in FIGS. 5A to 5D) while the specific test cases are being executed by the human tester.

When a specific high-level test case contains one or more steps that have already been included in any previous specific test case, those steps may be executed automatically by the system without the tester's intervention, along with the automatic low-level test model generation of the respective steps within the actual specific high-level test case.

Based on the above exemplary low-level test models of the specific high-level test cases, a computer-executable test program code is generated by the system of the invention in step 150 of the method. The computer-executable test program code is used for automatic execution of the low-level test models in the software under test. For the same low-level test model, a different executable program code may be generated for various software testing platforms.

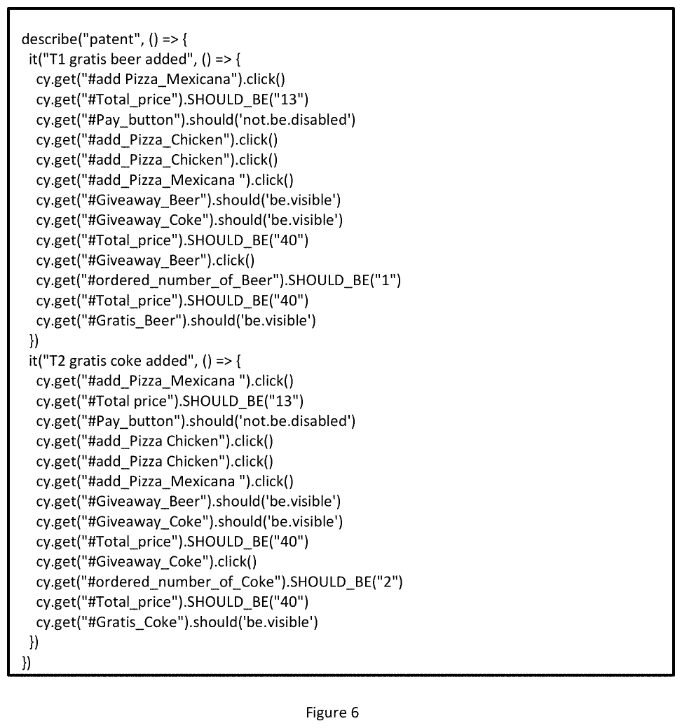

FIG. 6 shows an example of a computer-executable test program code generated for execution by Cypress, which is an exemplary test execution tool.

In the Cypress code shown in FIG. 6, the event #pressed of the low-level model corresponds to the event ‘click’, the status #active of the low-level model corresponds to the status ‘not.be.disabled’, etc.

As described above, based on a high-level test model, any computer-executable test program code can be generated for automated software testing. The computer-executable test program code can be executed any number of times to test the software during the software development life cycle. If necessary, the high-level test model may be modified in response to changes in the software to be tested.

When a high-level test model step changes, the corresponding steps of the high-level test cases will also be modified. The modified test steps should be re-executed by the human tester, while the other (unchanged) steps are executed automatically by the system. The computer-executable test program code of the modified specific high-level test cases are generated again.

In another embodiment, a system for test code generation is provided. The system comprises a computing device configured to provide a high-level test model for modelling a set of requirements for the software to be tested; generate a plurality of high-level test cases, by means of a test case generation module, on the basis of the high-level test model; provide a human tester with the software to be tested, said software being implemented on the basis of said set of requirements; execute the software controlled by a test automation tool; prompt the human tester to execute the high-level test cases by the software under test with using input values arbitrarily selected from an available set of input values of the software in accordance with the high-level test model; produce a plurality of low-level test models, by means of the test automation tool, for the high-level test cases by the human tester; and generate a computer-executable test program code for the low-level test models by the test automation tool.

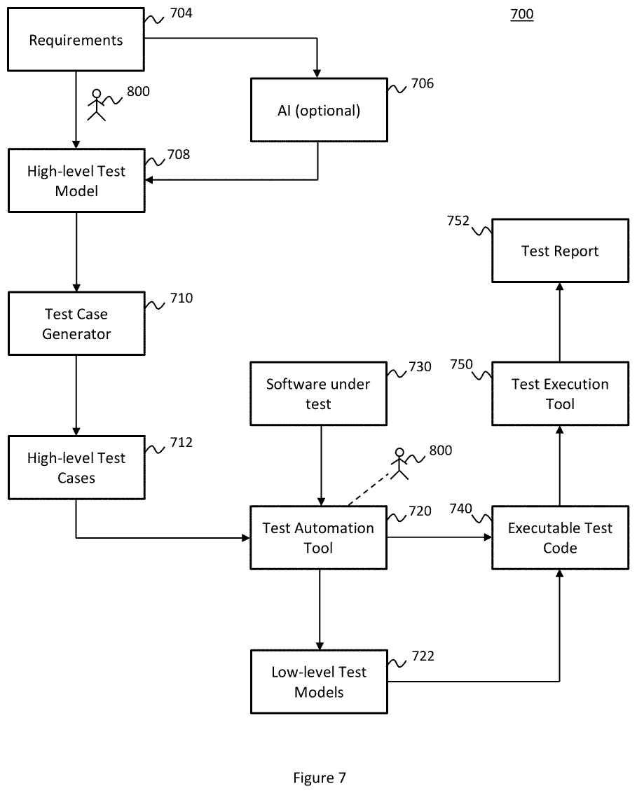

FIG. 7 illustrates the components of a system 700 for automatic test code generation in accordance with the present invention. The system 700 comprises a test case generator module 710 that produces a plurality of high-level test cases 712 on the basis of a high-level test model 708 using a predefined syntax. The high-level test model 708 may be produced by an artificial intelligence (AI) tool 706 or by a human tester 800 on the basis of written (human interpretable) software requirements 704.

The high-level test cases 712 are read by a test automation tool 720, such as Harmony of 4Test-Plus Kft., and are used to assist the human tester 800 in executing the specific high-level test cases with the software 730 under test. The test automation tool 720 produces a low-level test model 722 for each step of the high-level test model 708 when the human tester 800 executes the high-level test cases 712 with using the required values of the input parameters of the software 730 under test and checks the responses of the software 730.

The test automation tool 720 also functions to produce a computer-executable test program code 740 for execution based on the low-level test models. The computer-executable code is then executed by a test execution tool 750. For example, the test execution tool 750 may be Cypress, which is a JavaScript-based end-to-end testing framework, but other platforms may also be appreciated. The computer-executable test code 740 may be used for testing the software 730 at any time during the development life cycle of the software 730. Preferably, the test execution tool 750 also generates a test report 752 as a result of execution of the test program code 740 for the software 730.

In one embodiment of the system, at least the test case generator module 710, the test automation tool 720 and the test execution tool 750 are implemented by software executing on a computing device. The computing device comprises a processor and a memory for executing the method of the invention.

The software requirements 704, the high-level test model 708, the high-level test cases 712, the low-level test model 722 and the computer-executable test program code 740 are data files stored on a non-transitory computer-readable medium and loaded into the memory of the computing device during the test code generation process and the software testing process.

In another embodiment, a non-transitory computer-readable medium encoded with programming instructions configurable to cause a computing device to perform the above described method of the invention for test code generation is provided.

The foregoing description is merely illustrative in nature and is not intended to limit the embodiments of the subject matter or the application and uses of such embodiments. Furthermore, there is no intention to be bound by any expressed or implied theory presented in the technical field, background, or the detailed description. As used herein, the word “exemplary” or “example” means “serving as an example, instance, or illustration.” Any implementation described herein as exemplary is not necessarily to be construed as preferred or advantageous over other implementations, and the exemplary embodiments described herein are not intended to limit the scope or applicability of the subject matter in any way.

Embodiments of the subject matter may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processing systems or devices can carry out the described operations, tasks, and functions by manipulating electrical signals representing data bits at accessible memory locations, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices. When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “processor-readable medium” or “machine-readable medium” may include any non-transitory medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like. In this regard, the subject matter described herein can be implemented in the context of any computer-implemented system and/or in connection with two or more separate and distinct computer-implemented systems that cooperate and communicate with one another.

As used herein, the term “module” refers to any hardware, software, firmware, electronic control component, processing logic, and/or processor device, individually or in any combination, including without limitation: application specific integrated circuit (ASIC), a field-programmable gate-array (FPGA), an electronic circuit, a processor (shared, dedicated, or group) and memory that executes one or more software or firmware programs, a combinational logic circuit, and/or other suitable components that provide the described functionality.

While at least one exemplary embodiment has been presented, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application. Accordingly, details of the exemplary embodiments or other limitations described above should not be read into the claims absent a clear intention to the contrary.

What we claim is:

1. A computer-implemented method of producing a test code for automated testing a software, the method comprising:
providing a high-level test model for modelling a set of requirements for the software to be tested;
generating a plurality of high-level test cases, by means of a test case generation module, on the basis of the high-level test model;
providing a human tester with the software to be tested, said software being implemented on the basis of said set of requirements;
executing the software controlled by a test automation tool;
prompting the human tester to execute the high-level test cases by the software under test with using input values arbitrarily selected from an available set of input values of the software in accordance with the high-level test model;
producing a plurality of low-level test models, by means of the test automation tool, for the high-level test cases by the human tester; and
generating a computer-executable test program code for the low-level test models by the test automation tool.

2. The computer-implemented method of claim 1, wherein all possible high-level test cases are generated for the high-level test model.

3. A system for test code generation, the system comprising a computing device configured to:
provide a high-level test model for modelling a set of requirements for the software to be tested;
generate a plurality of high-level test cases, by means of a test case generation module, on the basis of the high-level test model;
provide a human tester with the software to be tested, said software being implemented on the basis of said set of requirements;
execute the software controlled by a test automation tool;
prompt the human tester to execute the high-level test cases by the software under test with using input values arbitrarily selected from an available set of input values of the software in accordance with the high-level test model;
produce a plurality of low-level test models, by means of the test automation tool, for the high-level test cases by the human tester; and
generate a computer-executable test program code for the low-level test models by the test automation tool.

4. A non-transitory computer-readable medium encoded with programming instructions configurable to cause a computing device to perform a method for test code generation, the method comprising:
providing a high-level test model for modelling a set of requirements for the software to be tested;
generating a plurality of high-level test cases, by means of a test case generation module, on the basis of the high-level test model;
providing a human tester with the software to be tested, said software being implemented on the basis of said set of requirements;
executing the software controlled by a test automation tool;
prompting the human tester to execute the high-level test cases by the software under test with using input values arbitrarily selected from an available set of input values of the software in accordance with the high-level test model;
producing a plurality of low-level test models, by means of the test automation tool, for the high-level test cases by the human tester; and
generating a computer-executable test program code for the low-level test models by the test automation tool.
